(19) United States
(12) Patent Application Publication
(10) Pub. No.: US 2026/0088743 A1
(43) Pub. Date: Mar. 26, 2026

(54) POWER CONVERTING APPARATUS, MOTOR DRIVE DEVICE, AND REFRIGERATION CYCLE-INCORPORATING DEVICE

(71) Applicant: Mitsubishi Electric Corporation, Tokyo (JP)

(72) Inventors: Shinya TOYODOME, Tokyo (JP); Kazunori HATAKEYAMA, Tokyo (JP); Ryoichi SASAKI, Tokyo (JP); Koichi ARISAWA, Tokyo (JP)

(21) Appl. No.: 19/110,240

(22) PCT Filed: Oct. 5, 2022
(86) PCT No.: PCT/JP2022/037262

§ 371 Date: Mar. 10, 2025

(51) Int. Cl. H02P 23/06; H02P 27/14

(52) U.S. Cl. CPC H02P 23/06; H02P 27/14

(57) ABSTRACT

A power converting apparatus includes a rectifier unit that rectifies first alternating-current power supplied from a commercial power supply, a smoothing capacitor connected to an output end of the rectifier unit, an inverter connected across the smoothing capacitor to generate second alternating-current power and to output the second alternating-current power to the motor, and a control device that controls a rotational speed of the motor by controlling an operation of the inverter. The control device performs reduction control of reducing pulsatile components generated due to effects of dead times of switching elements included in the inverter and due to an effect of a distortion of an induced voltage of the motor, superimposed on a three-phase current output from the inverter to the motor.

### CROSS REFERENCE TO RELATED APPLICATION

This application is a U.S. national stage application of PCT/JP2022/037262 filed on Oct. 5, 2022, the contents of which are incorporated herein by reference.

### FIELD

The present disclosure relates to a power converting apparatus for converting alternating-current (AC) power into desired power, a motor drive device, and a refrigeration cycle-incorporating device.

### BACKGROUND

A conventional power converting apparatus that controls switching of an inverter to control driving of a motor is subjected to harmonic components generated due to effects of operation of devices such as the inverter and the motor. A harmonic component having an effect on measurement values such as a current value and a voltage value and/or on an estimated motor position will make it difficult for the power converting apparatus to perform high accuracy control. Against such problem, Patent Literature 1 discloses a technology to reduce sixth spatial harmonics generated during motor operation.

### PATENT LITERATURE

Patent Literature 1: Japanese Patent Application Laid-open No. 2013-255314

However, the foregoing conventional technology is directed only to sixth spatial harmonics generated during motor operation. In motor control operation, an electrical 6f component is superimposed on a d-axis current and on a q-axis current represented using a dq rotating coordinate system, which rotates in synchronization with the rotor position of the motor. The electrical 6f component is a pulsatile component having a frequency that is six times the electrical angular frequency based on rotation of the motor. Superimposition of an electrical 6f component on the d-axis current and on the q-axis current is accounted for by various factors. This therefore presents a problem in that performing merely control using the foregoing conventional technology is not sufficient.

### SUMMARY

The present disclosure has been made in view of the foregoing, and it is an object of the present disclosure to provide a power converting apparatus capable of reducing pulsatile components induced by the inverter and by the motor.

In order to solve the above-described problem and achieve the object, a power converting apparatus according to the present disclosure comprises: a rectifier unit rectifying first alternating-current power supplied from a commercial power supply; a capacitor connected to an output end of the rectifier unit; an inverter connected across the capacitor, the inverter generating second alternating-current power and outputting the second alternating-current power to a motor; and a control device controlling a rotational speed of the motor by controlling an operation of the inverter. The control device performs reduction control of reducing a pulsatile component, the pulsatile component being generated due to an effect of a dead time of a switching element included in the inverter and due to an effect of a distortion of an induced voltage of the motor, the pulsatile component being superimposed on a three-phase current output from the inverter to the motor.

A power converting apparatus according to the present disclosure provides an advantage in capability of reducing pulsatile components induced by the inverter and by the motor.

### BRIEF DESCRIPTION OF DRAWINGS

FIG. 1 is a diagram illustrating an exemplary configuration of a power converting apparatus according to a first embodiment.

FIG. 2 is a diagram illustrating an exemplary configuration of an inverter included in the power converting apparatus according to the first embodiment.

FIG. 3 is a block diagram illustrating an exemplary configuration of a control device included in the power converting apparatus according to the first embodiment.

FIG. 4 is a block diagram illustrating an exemplary configuration of a voltage command value calculation unit included in the control device of the power converting apparatus according to the first embodiment.

FIG. 5 is a block diagram illustrating an exemplary configuration of a d-axis current control unit included in the voltage command value calculation unit of the control device in the power converting apparatus according to the first embodiment.

FIG. 6 is a block diagram illustrating an exemplary configuration of a q-axis current control unit included in the voltage command value calculation unit of the control device in the power converting apparatus according to the first embodiment.

FIG. 7 is a diagram illustrating, as a comparative example, an example of operational status of the power converting apparatus when no reduction control is performed to reduce pulsation of an electrical 6f component included in each current, by the control device of the power converting apparatus of the first embodiment.

FIG. 8 is a diagram illustrating an example of operational status of the power converting apparatus when reduction control is performed to reduce pulsation of the electrical 6f component included in a q-axis current, by the control device of the power converting apparatus of the first embodiment.

FIG. 9 is a diagram illustrating an example of operational status of the power converting apparatus when reduction control is performed to reduce pulsation of the electrical 6f component included in a d-axis current and in the q-axis current, by the control device of the power converting apparatus of the first embodiment.

FIG. 10 is a flowchart illustrating an operation of the power converting apparatus according to the first embodiment.

FIG. 11 is a diagram illustrating an example of hardware configuration for implementing the control device included in the power converting apparatus according to the first embodiment.

FIG. 12 is a block diagram illustrating an exemplary configuration of the voltage command value calculation unit included in the control device of the power converting apparatus according to a second embodiment.

FIG. 13 is a block diagram illustrating an exemplary configuration of the d-axis current control unit included in the voltage command value calculation unit of the control device in the power converting apparatus according to the second embodiment.

FIG. 14 is a block diagram illustrating an exemplary configuration of the q-axis current control unit included in the voltage command value calculation unit of the control device in the power converting apparatus according to the second embodiment.

FIG. 15 is a diagram illustrating an exemplary configuration of a refrigeration cycle-incorporating device according to a third embodiment.

### DETAILED DESCRIPTION

A power converting apparatus, a motor drive device, and a refrigeration cycle-incorporating device according to embodiments of the present disclosure will be described in detail below with reference to the drawings.

### First Embodiment

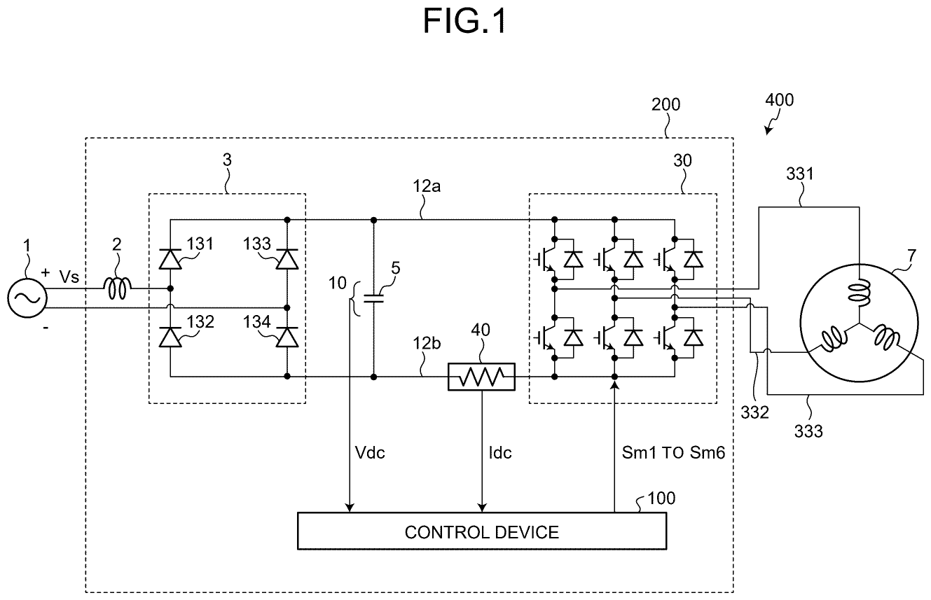

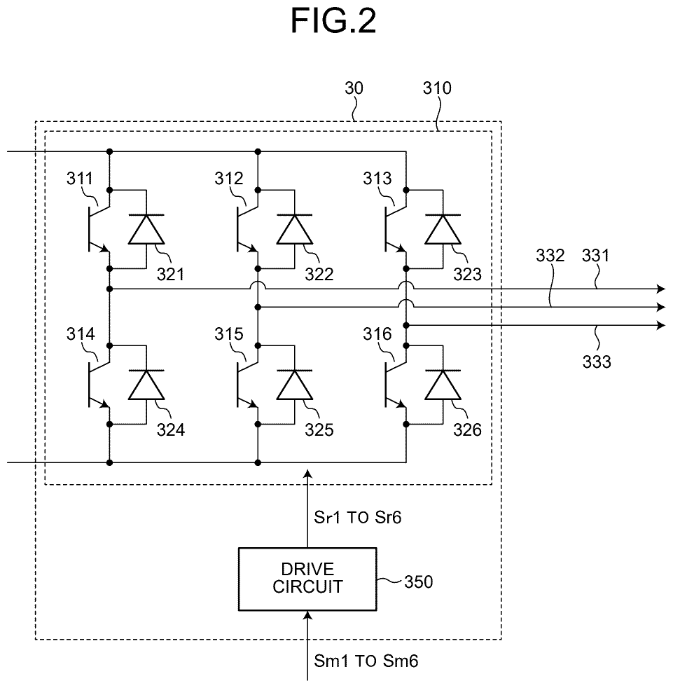

FIG. 1 is a diagram illustrating an exemplary configuration of a power converting apparatus 200 according to a first embodiment. FIG. 2 is a diagram illustrating an exemplary configuration of an inverter 30 included in the power converting apparatus 200 according to the first embodiment. The power converting apparatus 200 is connected to a commercial power supply 1 and to a motor 7. The power converting apparatus 200 converts first alternating-current (AC) power having a supply voltage Vs supplied from the commercial power supply 1 into second AC power having a desired amplitude and a desired phase, and supplies the second AC power to the motor 7. The power converting apparatus 200 includes a reactor 2, a rectifier unit 3, a smoothing capacitor 5, an inverter 30, a bus voltage detection unit 10, a load current detection unit 40, and a control device 100. Note that the power converting apparatus 200 and the motor 7 together form a motor drive device 400.

The reactor 2 is connected between the commercial power supply 1 and the rectifier unit 3. The rectifier unit 3 includes a bridge circuit including rectifier elements 131 to 134. The rectifier unit 3 rectifies the first AC power having the supply voltage Vs supplied from the commercial power supply 1, and outputs the power obtained. The rectifier unit 3 performs full-wave rectification.

The smoothing capacitor 5 is a smoothing element that is connected to output ends of the rectifier unit 3 and smooths the power obtained by rectification performed by the rectifier unit 3. The smoothing capacitor 5 is a capacitor such as, for example, an electrolytic capacitor or a film capacitor. The smoothing capacitor 5 has a capacity sufficient for smoothing the power obtained by rectification performed by the rectifier unit 3. The voltage across the smoothing capacitor 5 generated by smoothing does not have a full-wave rectified waveform of the commercial power supply 1, but has a waveform including a voltage ripple that is dependent on the frequency of the commercial power supply 1 and superimposed on a direct-current (DC) component. The foregoing voltage across the smoothing capacitor 5 thus does not pulsate largely. This voltage ripple has a frequency twice the frequency of the supply voltage Vs when the commercial power supply 1 is a single-phase power supply, and has a main component at a frequency six times the frequency of the supply voltage Vs when the commercial power supply 1 is a three-phase power supply.

The bus voltage detection unit 10 is a detection unit that detects the voltage across both ends of the smoothing capacitor 5, i.e., the voltage across DC buses 12a and 12b, as a bus voltage Vdc, and outputs a voltage value detected, to the control device 100. The load current detection unit 40 is a detection unit that detects a load current Idc, which is a DC current flowing from the smoothing capacitor 5 into the inverter 30, and outputs a current value detected, to the control device 100.

The inverter 30 is connected across the smoothing capacitor 5. The inverter 30 converts the power output from the rectifier unit 3 and the smoothing capacitor 5 into second AC power having a desired amplitude and a desired phase, that is, generates the second AC power, and outputs the second AC power to the motor 7. Specifically, the inverter 30 receives the bus voltage Vdc, generates a three-phase AC voltage having a variable frequency and a variable voltage value, and supplies the three-phase AC voltage through output lines 331 to 333 to the motor 7. As illustrated in FIG. 2, the inverter 30 includes an inverter main circuit 310 and a drive circuit 350. The inverter main circuit 310 has input terminals respectively connected to the DC buses 12a and 12b. The inverter main circuit 310 includes switching elements 311 to 316. The switching elements 311 to 316 are respectively connected with freewheeling rectifier elements 321 to 326 in antiparallel therewith.

The drive circuit 350 generates drive signals Sr1 to Sr6 on the basis of pulse width modulation (PWM) signals Sm1 to Sm6 output from the control device 100. The drive circuit 350 controls on-off switching of the switching elements 311 to 316 according to the drive signals Sr1 to Sr6. This enables the inverter 30 to supply a three-phase AC voltage having a variable frequency and a variable voltage through the output lines 331 to 333 to the motor 7.

The PWM signals Sm1 to Sm6 are each a signal having a signal level of a logic circuit, i.e., a magnitude from 0 V to 5 V. The PWM signals Sm1 to Sm6 are each a signal having a reference potential that is the ground potential of the control device 100. Meanwhile, the drive signals Sr1 to Sr6 are each a signal having a voltage level required for controlling a corresponding one of the switching elements 311 to 316, e.g., a magnitude from −15 V to +15 V. The drive signals Sr1 to Sr6 are each a signal having a reference potential that is the potential of the negative terminal, i.e., the emitter terminal, of the corresponding one of the switching elements 311 to 316.

The motor 7 rotates depending on the amplitude and on the phase of the second AC power supplied from the inverter 30. The motor 7 is used for, for example, compression operation in a compressor, rotation operation of a fan, and/or the like. Although FIG. 1 illustrates the motor 7 as having motor windings forming a Y connection, this is by way of example and not limitation. The motor 7 may have motor windings in a delta (Δ) connection, or may be designed to be switchable between a Y connection and a Δ connection.

Note that the disposing arrangement of the components of the power converting apparatus 200 illustrated in FIG. 1 is by way of example, and is not limited to the disposing arrangement in the example illustrated in FIG. 1. For example, the reactor 2 may be disposed downstream of the rectifier unit 3. In addition, the power converting apparatus 200 may include a booster unit, or the rectifier unit 3 may be configured to have functionality of a booster unit. The bus voltage detection unit 10 and the load current detection unit 40 may each be referred to hereinafter as detection unit. In addition, the voltage value detected by the bus voltage detection unit 10 and the current value detected by the load current detection unit 40 may each be referred to hereinafter as detection value.

The control device 100 obtains the bus voltage Vdc from the bus voltage detection unit 10, and obtains the load current Idc from the load current detection unit 40. The control device 100 controls operation of the inverter main circuit 310, specifically, on-off switching of the switching elements 311 to 316 included in the inverter main circuit 310, using the detection values detected by the detection units. The control device 100 controls on-off switching of the switching elements 311 to 316 included in the inverter main circuit 310 to thereby control the rotational speed of the motor 7. In addition, the control device 100 calculates the load torque of the motor 7. Note that the control device 100 does not necessarily need to use all the detection values obtained from the detection units, but may perform control using part of the detection values. In the present embodiment, the control device 100 performs control in a rotating coordinate system having a d-axis and a q-axis.

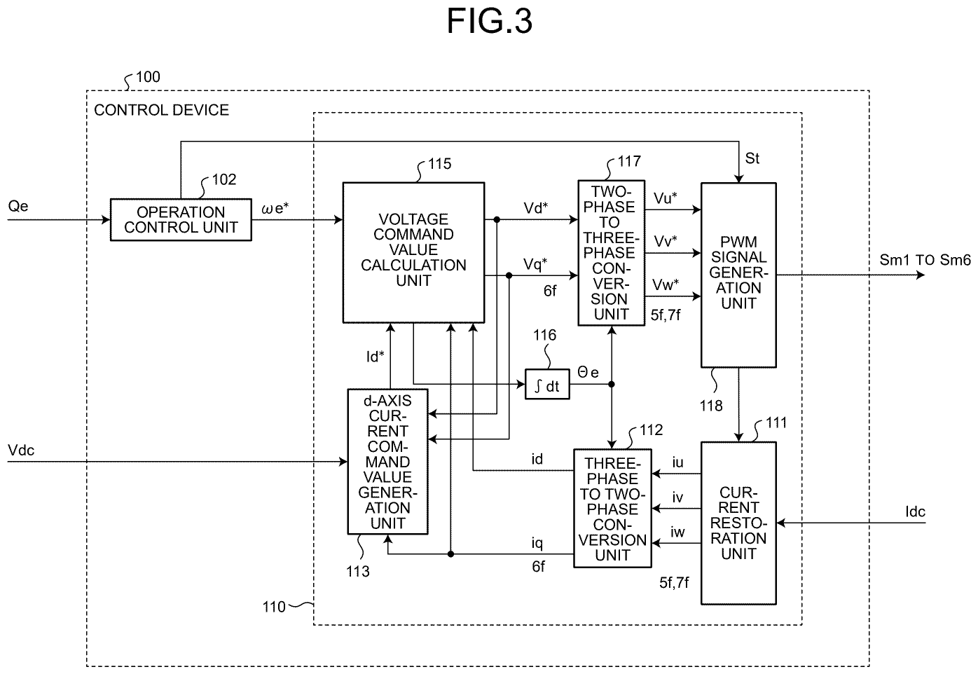

Detailed configuration and operation of the control device 100 will next be described. FIG. 3 is a block diagram illustrating an exemplary configuration of the control device 100 included in the power converting apparatus 200 according to the first embodiment. The control device 100 includes an operation control unit 102 and an inverter control unit 110.

The operation control unit 102 obtains command information Qe from an external device. For example, when the power converting apparatus 200 is installed in an air conditioner, which is a refrigeration cycle-incorporating device, the command information Qe is information based on a temperature detected by a temperature sensor (not illustrated), information representing a setting temperature specified from a remote controller, which is an operation unit (not illustrated), operation mode selection information, information on instructions to start operation and stop operation, and the like. Examples of the operation mode include heating, cooling, and dehumidification. The operation control unit 102 generates a frequency command value ωe* for generating a voltage command value on the basis of the command information Qe. The voltage command value is a command value for a voltage to be applied to the motor 7. The operation control unit 102 can determine the frequency command value ωe* by multiplying a rotational angular velocity command value ωm* by a number of pole pairs Pm of the motor 7. The rotational angular velocity command value ωm* is a command value for a rotational speed of the motor 7. The operation control unit 102 also generates a stop signal St on the basis of the command information Qe, where the stop signal St is a signal for stopping operation of the inverter 30. The operation control unit 102 outputs the frequency command value ωe* to a voltage command value calculation unit 115 of the inverter control unit 110, and outputs the stop signal St to a PWM signal generation unit 118 of the inverter control unit 110.

The inverter control unit 110 includes a current restoration unit 111, a three-phase to two-phase conversion unit 112, a d-axis current command value generation unit 113, the voltage command value calculation unit 115, an electrical phase calculation unit 116, a two-phase to three-phase conversion unit 117, and the PWM signal generation unit 118.

The current restoration unit 111 restores phase currents iu, iv, and iw flowing into the motor 7 on the basis of the load current Idc detected by the load current detection unit 40. The current restoration unit 111 can restore the phase currents iu, iv, and iw by sampling the load current Idc detected by the load current detection unit 40 at timings determined on the basis of the PWM signals Sm1 to Sm6 generated by the PWM signal generation unit 118.

The three-phase to two-phase conversion unit 112 converts the phase currents iu, iv, and iw restored by the current restoration unit 111 into a d-axis current id and a q-axis current iq, i.e., current values along dq axes, using an electrical phase Oe generated by the electrical phase calculation unit 116, described later, where the d-axis current id is an excitation current, and the q-axis current iq is a torque current.

The d-axis current command value generation unit 113 generates a d-axis current command value Id* in the aforementioned rotating coordinate system. Specifically, the d-axis current command value generation unit 113 determines a d-axis current command value Id* that is optimum to achieve the highest efficiency for driving the motor 7, on the basis of the q-axis current iq, the bus voltage Vdc, a d-axis voltage command value Vd*, and a q-axis voltage command value Vq*. On the basis of the q-axis current iq, the bus voltage Vdc, the d-axis voltage command value Vd*, and the q-axis voltage command value Vq*, the d-axis current command value generation unit 113 outputs a d-axis current command value Id* for providing a current phase βm that will cause the output torque of the motor 7 to be greater than or equal to a predetermined value or to maximize the output torque of the motor 7, that is, a current phase βm that will cause the current value to be less than or equal to a predetermined value or to minimize the current value. Note that although the foregoing description has assumed that the d-axis current command value generation unit 113 determines the d-axis current command value Id* on the basis of values such as the q-axis current iq, this is by way of example and not limitation. A similar advantage can also be provided when the d-axis current command value generation unit 113 determines the d-axis current command value Id* on the basis of values such as the d-axis current id and the frequency command value ωe*. Moreover, the d-axis current command value generation unit 113 may determine the d-axis current command value Id* through flux-weakening control or the like.

The voltage command value calculation unit 115 generates the d-axis voltage command value Vd* and the q-axis voltage command value Vq* on the basis of the frequency command value ωe* obtained from the operation control unit 102, on the basis of the d-axis current id and the q-axis current iq obtained from the three-phase to two-phase conversion unit 112, and on the basis of the d-axis current command value Id* obtained from the d-axis current command value generation unit 113. In addition, the voltage command value calculation unit 115 estimates an estimated frequency value ωest on the basis of the d-axis voltage command value Vd*, the q-axis voltage command value Vq*, the d-axis current id, and the q-axis current iq.

The electrical phase calculation unit 116 integrates the estimated frequency value ωest obtained from the voltage command value calculation unit 115 to thereby calculate the electrical phase θe.

The two-phase to three-phase conversion unit 117 converts the d-axis voltage command value Vd* and the q-axis voltage command value Vq*, i.e., voltage command values in a two-phase coordinate system, obtained from the voltage command value calculation unit 115, into three-phase voltage command values Vu*, Vv*, and Vw* using the electrical phase θe obtained from the electrical phase calculation unit 116, where the three-phase voltage command values Vu*, Vv*, and Vw* are output voltage command values in a three-phase coordinate system.

The PWM signal generation unit 118 generates the PWM signals Sm1 to Sm6 on the basis of the three-phase voltage command values Vu*, Vv*, and Vw* obtained from the two-phase to three-phase conversion unit 117 and on the basis of the stop signal St obtained from the operation control unit 102. The PWM signal generation unit 118 can also stop the motor 7 by not outputting the PWM signals Sm1 to Sm6 according to the stop signal St.

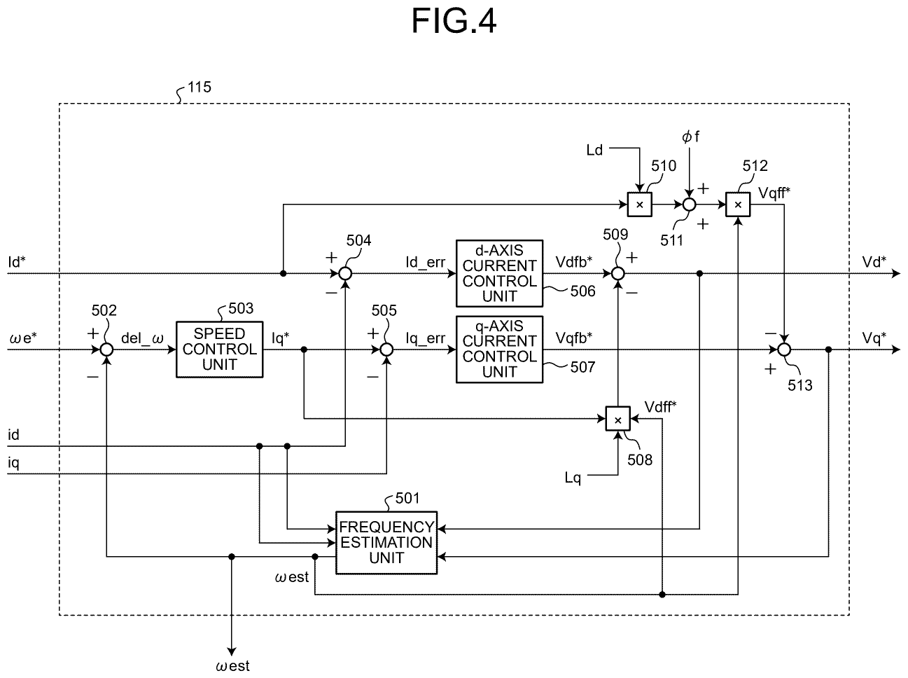

A configuration and an operation of the voltage command value calculation unit 115 will next be described in detail. FIG. 4 is a block diagram illustrating an exemplary configuration of the voltage command value calculation unit 115 included in the control device 100 of the power converting apparatus 200 according to the first embodiment. The voltage command value calculation unit 115 includes a frequency estimation unit 501, addition-subtraction units 502, 504, 505, 509, and 513, a speed control unit 503, a d-axis current control unit 506, a q-axis current control unit 507, multiplication units 508, 510, and 512, and an addition unit 511.

The frequency estimation unit 501 estimates the frequency of the voltage supplied to the motor 7 on the basis of d-axis current id, the q-axis current iq, the d-axis voltage command value Vd*, and the q-axis voltage command value Vq*, and outputs the frequency estimated, as the estimated frequency value ωest. Note that the estimated frequency value ωest output from the frequency estimation unit 501 to outside the voltage command value calculation unit 115 in the drawing of FIG. 4 is the estimated frequency value ωest output from the voltage command value calculation unit 115 to the electrical phase calculation unit 116 in the drawing of FIG. 3. The addition-subtraction unit 502 subtracts the estimated frequency value ωest from the frequency command value ωe*, and outputs a frequency deviation del_ω between the frequency command value ωe* and the estimated frequency value ωest.

The speed control unit 503 calculates a q-axis current command value Iq* on the basis of the frequency deviation del_ω, and outputs the q-axis current command value Iq*. The q-axis current command value Iq* is a command value for the q-axis current iq that causes the frequency deviation del_ω to be zero, that is, a command value for the q-axis current iq for providing a match between the frequency command value ωe* and the estimated frequency value ωest. The speed control unit 503 is, for example, but not limited to, a proportional-integral (PI) controller.

The addition-subtraction unit 504 subtracts the d-axis current id from the d-axis current command value Id*, and outputs a deviation Id_err between the d-axis current command value Id* and the d-axis current id. The d-axis current control unit 506 performs PI control and performs, in parallel therewith, reduction control to reduce a pulsatile component generated due to effects of dead times of the switching elements 311 to 316 included in the inverter 30 and due to an effect of a distortion of an induced voltage of the motor 7, and thus operates to cause the deviation between the d-axis current command value Id* and the d-axis current id to converge to zero. The d-axis current control unit 506 outputs a first d-axis voltage command value Vdfb*. Detailed configuration and operation of the d-axis current control unit 506 will be described later.

The addition-subtraction unit 505 subtracts the q-axis current iq from the q-axis current command value Iq*, and outputs a deviation Iq_err between the q-axis current command value Iq* and the q-axis current iq. The q-axis current control unit 507 performs PI control and performs, in parallel therewith, reduction control to reduce a pulsatile component generated due to effects of dead times of the switching elements 311 to 316 included in the inverter 30 and due to an effect of a distortion of an induced voltage of the motor 7, and thus operates to cause the deviation between the q-axis current command value Iq* and the q-axis current iq to converge to zero. The q-axis current control unit 507 outputs a first q-axis voltage command value Vqfb*. Detailed configuration and operation of the q-axis current control unit 507 will be described later.

The multiplication unit 508 multiplies the q-axis current command value Iq* by a q-axis inductance Lq of the motor 7 and by the estimated frequency value ωest to calculate and output a compensation value Vdff* for the first d-axis voltage command value Vdfb *. The addition-subtraction unit 509 subtracts the compensation value Vdff* from the first d-axis voltage command value Vdfb*, and outputs a second d-axis voltage command value as the d-axis voltage command value Vd* to be output from the voltage command value calculation unit 115, where the second d-axis voltage command value is a deviation between the first d-axis voltage command value Vdfb* and the compensation value Vdff* (i.e., Vdfb*−Vdff*).

The multiplication unit 510 multiplies the d-axis current command value Id* by a d-axis inductance Ld of the motor 7, and outputs a product thereof. The addition unit 511 adds a number-of-flux-linkages vector φf of the motor 7 to the output from the multiplication unit 510. The multiplication unit 512 multiplies the output from the addition unit 511 by the estimated frequency value ωest to calculate and output a compensation value Vqff* for the first q-axis voltage command value Vqfb*. The addition-subtraction unit 513 subtracts the compensation value Vqff* from the first q-axis voltage command value Vqfb*, and outputs a second q-axis voltage command value as the q-axis voltage command value Vq* to be output from the voltage command value calculation unit 115, where the second q-axis voltage command value is a deviation between the first q-axis voltage command value Vqfb* and the compensation value Vqff* (i.e., Vqfb*−Vqff*).

The following description describes control performed in the power converting apparatus 200, by the control device 100, to reduce a harmonic component having a frequency six times the electrical angular frequency based on rotation of the motor 7, included in each of the d-axis current id and the q-axis current iq. For brevity of explanation, a harmonic component having a frequency that is six times the electrical angular frequency based on rotation of the motor 7 will hereinafter be referred to as electrical 6f component. Specifically, in the voltage command value calculation unit 115 of the control device 100, the d-axis current control unit 506 performs reduction control of reducing the electrical 6f component included in the d-axis current id, and the q-axis current control unit 507 performs reduction control of reducing the electrical 6f component included in the q-axis current iq. Detailed configuration and operation of the d-axis current control unit 506 and of the q-axis current control unit 507 will next be described.

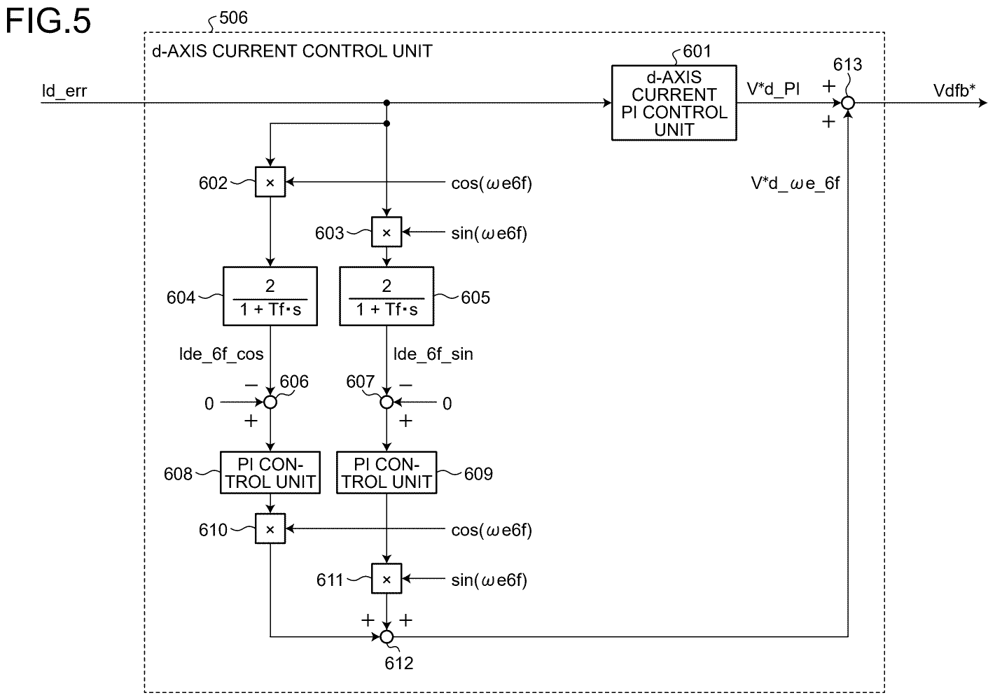

FIG. 5 is a block diagram illustrating an exemplary configuration of the d-axis current control unit 506 included in the voltage command value calculation unit 115 of the control device 100 in the power converting apparatus 200 according to the first embodiment. The d-axis current control unit 506 includes a d-axis current PI control unit 601, multiplication units 602, 603, 610, and 611, low-pass filters 604 and 605, addition-subtraction units 606 and 607, PI control units 608 and 609, and addition units 612 and 613. As illustrated in FIG. 5, the d-axis current control unit 506 is configured in which the d-axis current PI control unit 601 and a group of components from the multiplication unit 602 to the addition unit 612 perform control operations in parallel.

The d-axis current PI control unit 601 is a controller that performs current control, through a proportional-integral operation, on the deviation Id_err between the d-axis current command value Id* and the d-axis current id, output from the addition-subtraction unit 504, in the voltage command value calculation unit 115 of a common type. The d-axis current PI control unit 601 outputs a d-axis voltage command value V*d_PI.

To extract a cosine component of the electrical 6f component included in the deviation Id_err output from the addition-subtraction unit 504, the multiplication unit 602 first multiplies the deviation Id_err by cos(ωe6f). The frequency ωe6f has a value that is six times the electrical phase θe calculated by the electrical phase calculation unit 116. The d-axis current control unit 506 may calculate the value ωe6f internally or by using the electrical phase Oe calculated by the electrical phase calculation unit 116. The value calculated by the multiplication unit 602 includes not only the pulsatile component having the frequency of ωe6f, but also a pulsatile component having a frequency higher than ωe6f, i.e., a harmonic component.

To extract a sine component of the electrical 6f component included in the deviation Id_err output from the addition-subtraction unit 504, the multiplication unit 603 first multiplies the deviation Id_err by sin(ωe6f). The frequency ωe6f has a value the same as the value used by the multiplication unit 602. The value calculated by the multiplication unit 603 includes not only the pulsatile component having the frequency of ωe6f, but also a pulsatile component having a frequency higher than ωe6f, i.e., a harmonic component.

The low-pass filters 604 and 605 are each a first-order delay filter having a transfer function represented by 2/(1+Tf·s), where “s” is a Laplace operator. The value Tf is a time constant, and is determined to remove pulsatile components having frequencies higher than the frequency ωe6f. Note that the term “to remove” includes a case where part of the pulsatile components are decayed, or reduced. The time constant Tf may be set in the operation control unit 102 on the basis of the speed command, and provided to the low-pass filters 604 and 605 by the operation control unit 102, or may be stored in advance in the low-pass filters 604 and 605. The low-pass filters 604 and 605 have been described each as a first-order delay filter, but this is by way of example. The low-pass filters 604 and 605 may each be a moving-average filter or the like, and may each be a filter of any type that is capable of removing pulsatile components having higher frequencies. Note that the low-pass filters 604 and 605 halve the amplitude in the filtering operation, and this is why the transfer function has the numerator of “2” for doubling the value.

The low-pass filter 604 performs low-pass filtering on the output from the multiplication unit 602 to remove pulsatile components having frequencies higher than the frequency ωe6f, and outputs a low frequency component Ide_6f_cos. The low frequency component Ide_6f_cos is a direct current quantity representing a cosine component having the frequency of ωe6f of the pulsatile components of the deviation Id_err.

The low-pass filter 605 performs low-pass filtering on the output from the multiplication unit 603 to remove pulsatile components having frequencies higher than the frequency ωe6f, and outputs a low frequency component Ide_6f_sin. The low frequency component Ide_6f_sin is a direct current quantity representing a sine component having the frequency of ωe6f of the pulsatile components of the deviation Id_err.

The addition-subtraction unit 606 calculates a difference between the low frequency component Ide_6f_cos output from the low-pass filter 604 and a command value “0” (i.e., the difference: Ide_6f_cos−0). In this operation, the low frequency component Ide_6f_cos is desired to be reduced, specifically to zero ideally, and thus a command value of “0” is used. The control device 100 may use a command value other than “0” when control stability, noise, and the like will fall within satisfactory ranges.

The addition-subtraction unit 607 calculates a difference between the low frequency component Ide_6f_sin output from the low-pass filter 605 and a command value “0” (i.e., the difference: Ide_6f_sin−0). In this operation, the low frequency component Ide_6f_sin is desired to be reduced, specifically to zero ideally, and thus a command value of “0” is used. The control device 100 may use a command value other than “0” when control stability, noise, and the like will fall within satisfactory ranges.

The PI control unit 608 performs a proportional-integral operation on the difference calculated by the addition-subtraction unit 606 (i.e., Ide_6f_cos−0) to calculate a cosine component of a current command value that will make the difference (i.e., Ide_6f_cos−0) close to “0”. The PI control unit 608 performs control for causing the low frequency component Ide_6f_cos to match “0” by generating the cosine component of such current command value in this manner.

The PI control unit 609 performs a proportional-integral operation on the difference calculated by the addition-subtraction unit 607 (i.e., Ide_6f_sin−0) to calculate a sine component of the current command value that will make the difference (i.e., Ide_6f_sin−0) close to “0”. The PI control unit 609 performs control for causing the low frequency component Ide_6f_sin to match “0” by generating the sine component of such current command value in this manner.

The multiplication unit 610 multiplies the cosine component of the current command value output from the PI control unit 608, by cos(ωe6f). Because the output from the low-pass filter 604 is a direct current quantity as described above, the addition-subtraction unit 606 and the PI control unit 608 perform operation on a direct current quantity. The multiplication unit 610 therefore generates a command value including an AC component of ωe6f by multiplying the cosine component of the current command value output from the PI control unit 608, by cos(ωe6f).

The multiplication unit 611 multiplies the sine component of the current command value output from the PI control unit 609, by sin(ωe6f). Because the output from the low-pass filter 605 is a direct current quantity as described above, the addition-subtraction unit 607 and the PI control unit 609 perform operation on a direct current quantity. The multiplication unit 611 therefore generates a command value including an AC component of ωe6f by multiplying the sine component of the current command value output from the PI control unit 609, by sin(ωe6f).

The addition unit 612 adds together the command value including the AC component of ωe6f calculated by the multiplication unit 610 and the command value including the AC component of ωe6f calculated by the multiplication unit 611 to generate a compensation value V*d_ωe_6f having an AC value for compensating the d-axis voltage command value V*d_PI calculated by the d-axis current PI control unit 601, and outputs the compensation value V*d_ωe_6f.

The addition unit 613 adds together the d-axis voltage command value V*d_PI calculated by the d-axis current PI control unit 601 and the compensation value V*d_ωe_6f calculated by the addition unit 612 to generate and output the first d-axis voltage command value Vdfb*.

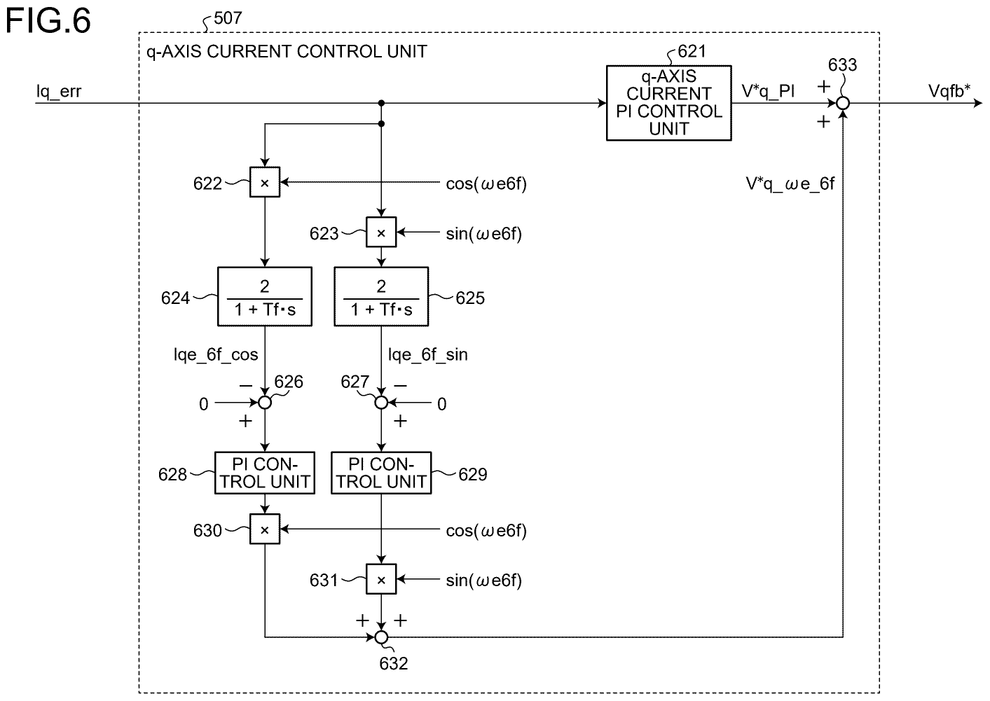

FIG. 6 is a block diagram illustrating an exemplary configuration of the q-axis current control unit 507 included in the voltage command value calculation unit 115 of the control device 100 in the power converting apparatus 200 according to the first embodiment. The q-axis current control unit 507 includes a q-axis current PI control unit 621, multiplication units 622, 623, 630, and 631, low-pass filters 624 and 625, addition-subtraction units 626 and 627, PI control units 628 and 629, and addition units 632 and 633. As illustrated in FIG. 6, the q-axis current control unit 507 is configured in which the q-axis current PI control unit 621 and a group of components from the multiplication unit 622 to the addition unit 632 perform control operations in parallel.

The q-axis current PI control unit 621 is a controller that performs current control, through a proportional-integral operation, on the deviation Iq_err between the q-axis current command value Iq* and the q-axis current iq, output from the addition-subtraction unit 505, in the voltage command value calculation unit 115 of a common type. The q-axis current PI control unit 621 outputs a q-axis voltage command value V*q_PI.

To extract a cosine component of the electrical 6f component included in the deviation Iq_err output from the addition-subtraction unit 505, the multiplication unit 622 first multiplies the deviation Iq_err by cos(ωe6f). The frequency ωe6f has a value that is six times the electrical phase Oe calculated by the electrical phase calculation unit 116. The q-axis current control unit 507 may calculate the value ωe6f internally or by using the electrical phase Oe calculated by the electrical phase calculation unit 116. The value calculated by the multiplication unit 622 includes not only the pulsatile component having the frequency of ωe6f, but also a pulsatile component having a frequency higher than ωe6f, i.e., a harmonic component.

To extract a sine component of the electrical 6f component included in the deviation Iq_err output from the addition-subtraction unit 505, the multiplication unit 623 first multiplies the deviation Iq_err by sin(ωe6f). The frequency ωe6f has a value the same as the value used by the multiplication unit 622. The value calculated by the multiplication unit 623 includes not only the pulsatile component having the frequency of ωe6f, but also a pulsatile component having a frequency higher than ωe6f, i.e., a harmonic component.

The low-pass filters 624 and 625 are each a first-order delay filter having a transfer function represented by 2/(1+Tf·s), where “s” is a Laplace operator. The value Tf is a time constant, and is determined to remove pulsatile components having frequencies higher than the frequency ωe6f. Note that the term “to remove” includes a case where part of the pulsatile components are decayed, or reduced. The time constant Tf may be set in the operation control unit 102 on the basis of the speed command, and provided to the low-pass filters 624 and 625 by the operation control unit 102, or may be stored in advance in the low-pass filters 624 and 625. The low-pass filters 624 and 625 have been described each as a first-order delay filter, but this is by way of example. The low-pass filters 624 and 625 may each be a moving-average filter or the like, and may each be a filter of any type that is capable of removing pulsatile components having higher frequencies. Note that the low-pass filters 624 and 625 halve the amplitude in the filtering operation, and this is why the transfer function has the numerator of “2” for doubling the value.

The low-pass filter 624 performs low-pass filtering on the output from the multiplication unit 622 to remove pulsatile components having frequencies higher than the frequency ωe6f, and outputs a low frequency component Iqe_6f_cos. The low frequency component Iqe_6f_cos is a direct current quantity representing a cosine component having the frequency of ωe6f of the pulsatile components of the deviation Iq_err.

The low-pass filter 625 performs low-pass filtering on the output from the multiplication unit 623 to remove pulsatile components having frequencies higher than the frequency ωe6f, and outputs a low frequency component Iqe_6f_sin. The low frequency component Iqe_6f_sin is a direct current quantity representing a sine component having the frequency of ωe6f of the pulsatile components of the deviation Iq_err.

The addition-subtraction unit 626 calculates a difference between the low frequency component Iqe_6f_cos output from the low-pass filter 624 and a command value “0” (i.e., the difference: Iqe_6f_cos−0). In this operation, the low frequency component Iqe_6f_cos is desired to be reduced, specifically to zero ideally, and thus a command value of “0” is used. The control device 100 may use a command value other than “0” when control stability, noise, and the like will fall within satisfactory ranges.

The addition-subtraction unit 627 calculates a difference between the low frequency component Iqe_6f_sin output from the low-pass filter 625 and a command value “0” (i.e., the difference: Iqe_6f_sin−0). In this operation, the low frequency component Iqe_6f_sin is desired to be reduced, specifically to zero ideally, and thus a command value of “0” is used. The control device 100 may use a command value other than “0” when control stability, noise, and the like will fall within satisfactory ranges.

The PI control unit 628 performs a proportional-integral operation on the difference calculated by the addition-subtraction unit 626 (i.e., Iqe_6f_cos−0) to calculate a cosine component of a current command value that will make the difference (i.e., Iqe_6f_cos−0) close to “0”. The PI control unit 628 performs control for causing the low frequency component Iqe_6f_cos to match “0” by generating the cosine component of such current command value in this manner.

The PI control unit 629 performs a proportional-integral operation on the difference calculated by the addition-subtraction unit 627 (i.e., Iqe_6f_sin−0) to calculate a sine component of the current command value that will make the difference (i.e., Iqe_6f_sin−0) close to “0”. The PI control unit 629 performs control for causing the low frequency component Iqe_6f_sin to “match 0” by generating the sine component of such current command value in this manner.

The multiplication unit 630 multiplies the cosine component of the current command value output from the PI control unit 628, by cos(ωe6f). Because the output from the low-pass filter 624 is a direct current quantity as described above, the addition-subtraction unit 626 and the PI control unit 628 perform operation on a direct current quantity. The multiplication unit 630 therefore generates a command value including an AC component of ωe6f by multiplying the cosine component of the current command value output from the PI control unit 628, by cos(ωe6f).

The multiplication unit 631 multiplies the sine component of the current command value output from the PI control unit 629, by sin(ωe6f). Because the output from the low-pass filter 625 is a direct current quantity as described above, the addition-subtraction unit 627 and the PI control unit 629 perform operation on a direct current quantity. The multiplication unit 631 therefore generates a command value including an AC component of ωe6f by multiplying the sine component of the current command value output from the PI control unit 629, by sin(ωe6f).

The addition unit 632 adds together the command value including the AC component of ωe6f calculated by the multiplication unit 630 and the command value including the AC component of ωe6f calculated by the multiplication unit 631 to generate a compensation value V*q_ωe_6f having an AC value for compensating the q-axis voltage command value V*q_PI calculated by the q-axis current PI control unit 621, and outputs the compensation value V*q_ωe_6f.

The addition unit 633 adds together the q-axis voltage command value V*q_PI calculated by the q-axis current PI control unit 621 and the compensation value V*q_ωe_6f calculated by the addition unit 632 to generate and output the first q-axis voltage command value Vqfb*.

As described above, the control device 100 performs reduction control of reducing pulsatile components. The pulsatile components are generated due to effects of dead times of the switching elements 311 to 316 included in the inverter 30 and due to an effect of a distortion of an induced voltage of the motor 7, and are superimposed on the three-phase current output from the inverter 30 to the motor 7. The three-phase current includes the phase currents iu, iv, and iw restored by the current restoration unit 111. Specifically, the control device 100 converts the three-phase current into the d-axis current id and the q-axis current iq represented using a dq rotating coordinate system, and, in parallel with the current control, performs control of extracting pulsatile components having a frequency that is six times the electrical angular frequency based on rotation of the motor 7, included in the d-axis current id and in the q-axis current iq, and reducing the pulsatile components extracted to generate voltage command values to control operation of the switching elements 311 to 316 of the inverter 30. In practice, in the voltage command value calculation unit 115 of the control device 100, the d-axis current control unit 506 performs reduction control of reducing the electrical 6f component included in the d-axis current id, and the q-axis current control unit 507 performs reduction control of reducing the electrical 6f component included in the q-axis current iq. This enables the control device 100 to reduce the pulsatile components of the electrical 6f component, generated due to effects of dead times of the switching elements 311 to 316 included in the inverter 30 and due to an effect of a distortion of an induced voltage of the motor 7.

Note that the electrical 6f component is a pulsatile component generated when the three-phase current flowing from the inverter 30 of the power converting apparatus 200 into the motor 7 is converted into the d-axis current id and the q-axis current iq in the dq coordinate system having a d-axis and a q-axis. In the context of the three-phase current flowing from the inverter 30 of the power converting apparatus 200 into the motor 7, the pulsatile components of the electrical 6f component superimposed on the d-axis current id and on the q-axis current iq are expressed as pulsatile components of an electrical 5f component or pulsatile components of an electrical 7f component. In FIG. 3, the different representations of the pulsatile components between before and after the control operation by the three-phase to two-phase conversion unit 112 and before and after the control operation by the two-phase to three-phase conversion unit 117 are indicated by “6f” and “5f, 7f”. Thus, the control device 100 can be regarded as a control device that performs control to reduce pulsatile components generated in the three-phase current and having frequencies five times and seven times the power supply frequency of the commercial power supply 1, or a control device that performs control to reduce pulsatile components each having a frequency that is six times the electrical angular frequency based on rotation of the motor 7, generated in the d-axis current id and in the q-axis current iq represented using a dq rotating coordinate system, obtained by conversion from the three-phase current.

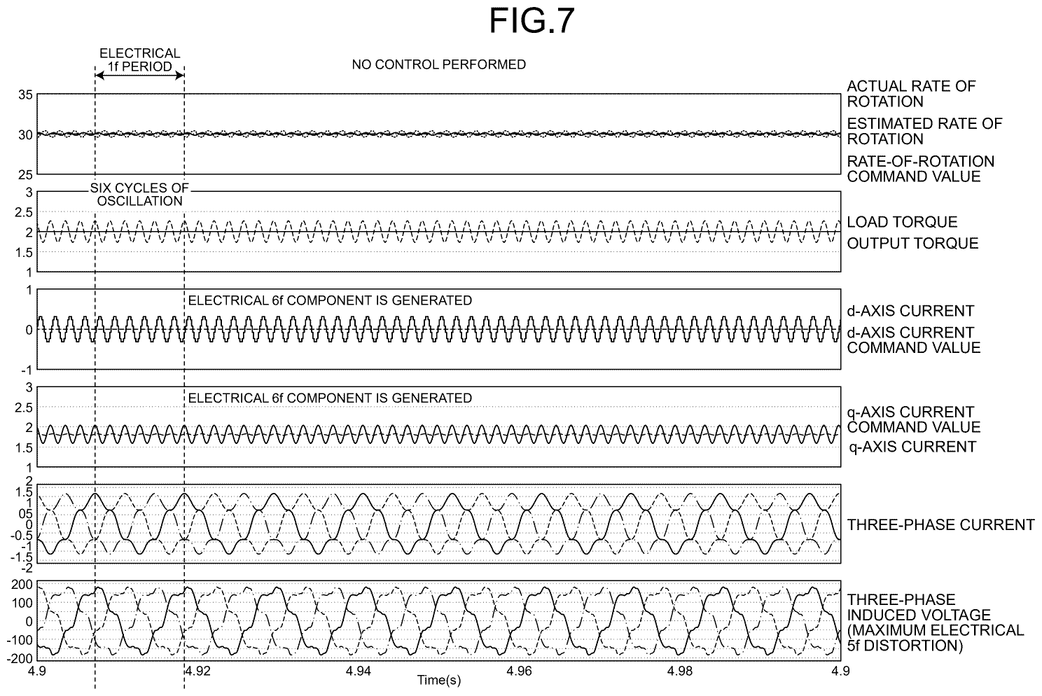

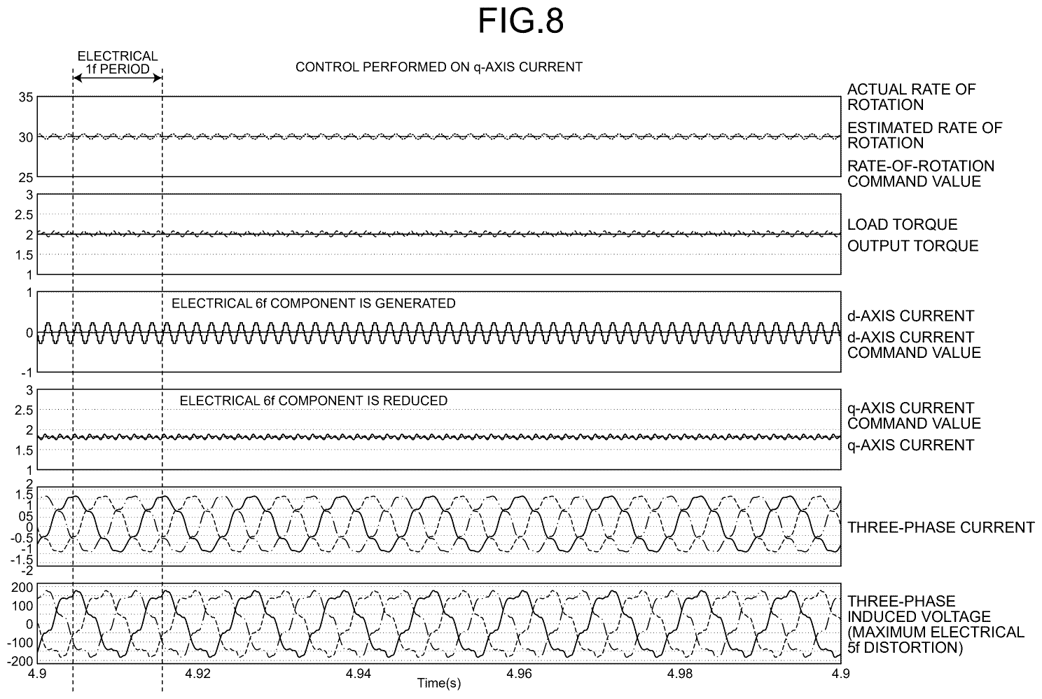

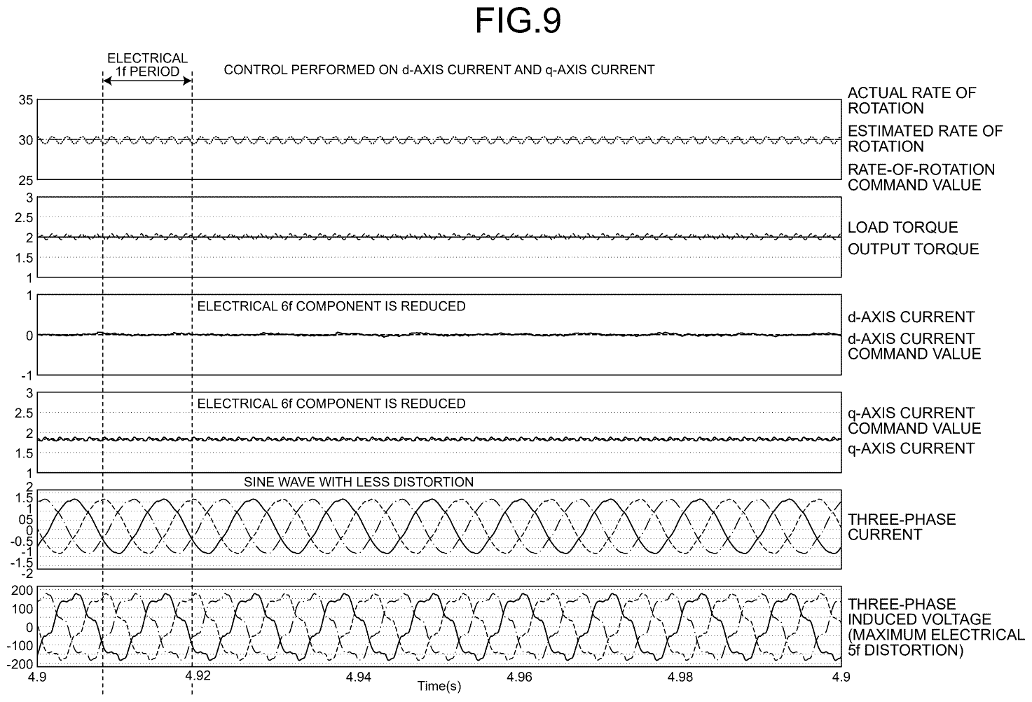

An advantage provided by the reduction control performed by the control device 100 according to the present embodiment will next be described. FIG. 7 is a diagram illustrating, as a comparative example, an example of operational status of the power converting apparatus 200 when no reduction control is performed to reduce pulsation of the electrical 6f component included in the currents, by the control device 100 of the power converting apparatus 200 of the first embodiment. FIG. 8 is a diagram illustrating an example of operational status of the power converting apparatus 200 when reduction control is performed to reduce pulsation of the electrical 6f component included in the q-axis current iq, by the control device 100 of the power converting apparatus 200 of the first embodiment. FIG. 9 is a diagram illustrating an example of operational status of the power converting apparatus 200 when reduction control is performed to reduce pulsation of the electrical 6f component included in the d-axis current id and in the q-axis current iq, by the control device 100 of the power converting apparatus 200 of the first embodiment. In FIGS. 7 to 9, the first graph from the top illustrates an actual rate of rotation of the motor 7 using a solid line, an estimated rate of rotation of the motor 7 using a broken line, and a rate-of-rotation command value for the motor 7 using a dashed-and-dotted line. The second graph from the top illustrates a load torque of the motor 7 using a solid line and an output torque from the inverter 30 for the motor 7 using a broken line. The third graph from the top illustrates the d-axis current id using a solid line and the d-axis current command value id* using a broken line. The fourth graph from the top illustrates the q-axis current command value iq* using a solid line and the q-axis current iq using a broken line. The fifth graph from the top illustrates the three-phase current. The sixth graph from the top illustrates a three-phase induced voltage including a largest amount of distortion caused by a pulsatile component of the electrical 5f component. Note that the horizontal axes represent time in all graphs.

A comparison between FIGS. 7 and 8 shows that performing control of reducing the pulsatile component of the electrical 6f component on the q-axis current iq by the control device 100 provides a significant improvement, that is, reduces pulsatile components significantly, in the output torque from the inverter 30 for the motor 7 and in the q-axis current iq. The comparison also shows that the pulsatile components are also reduced in the d-axis current id and in the three-phase current. Considering that the output torque from the inverter 30 is determined largely by factors such as the q-axis current iq and the q-axis voltage, the control device 100 can provide the advantage as described above even when the reduction control is performed only on the q-axis current iq. In addition, a comparison between FIGS. 8 and 9 shows that further performing control of reducing the pulsatile component of the electrical 6f component on the d-axis current id by the control device 100 provides a significant improvement, that is, reduces pulsatile components significantly, in the d-axis current id and in the three-phase current. Note that FIGS. 7 to 9 do not illustrate a case where the control device 100 performs control of reducing the pulsatile component of the electrical 6f component on the d-axis current id, but the control device 100 can also operate to perform control of reducing the pulsatile component of the electrical 6f component not on the q-axis current iq, but only on the d-axis current id. When, for example, noise or the like that will not affect the torque is generated in the power converting apparatus 200 or on the motor 7 due to pulsation of the d-axis current id, the control device 100 may be able to improve the noise by performing control only on the d-axis current id to reduce the pulsatile component of the electrical 6f component.

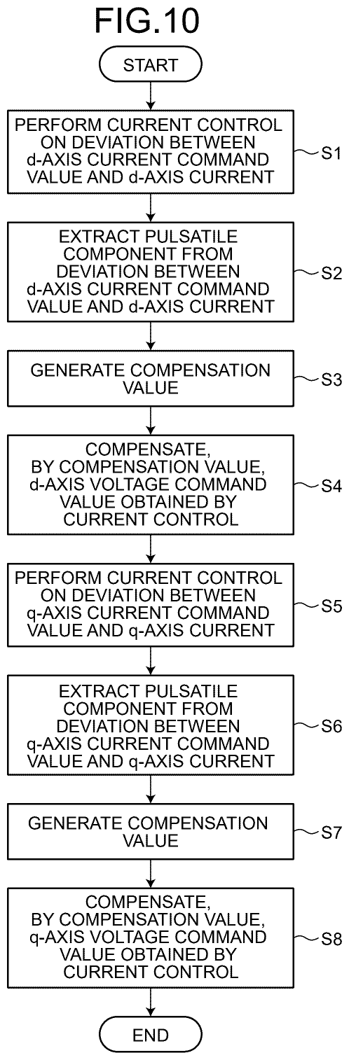

A characteristic operation of the control device 100 of the power converting apparatus 200 in the first embodiment will next be described using a flowchart. FIG. 10 is a flowchart illustrating an operation of the power converting apparatus 200 according to the first embodiment. In the power converting apparatus 200, the control device 100 performs current control on the deviation Id_err between the d-axis current command value Id* and the d-axis current id (step S1). The control device 100 extracts the pulsatile component of the electrical 6f component with respect to the d-axis current id, from the deviation Id_err between the d-axis current command value Id* and the d-axis current id (step S2). In practice, the control device 100 extracts the pulsatile component of the electrical 6f component from the deviation Id_err by dividing the electrical 6f component into a cosine component and a sine component as described above. The control device 100 generates the compensation value V*d_ωe_6f, which will reduce the pulsatile component of the electrical 6f component extracted, to “0” (step S3). The control device 100 compensates, by the compensation value V*d_ωe_6f, the d-axis voltage command value V*d_PI, which is the value obtained by performing current control on the deviation Id_err between the d-axis current command value Id* and the d-axis current id (step S4), thereby generates and outputs the first d-axis voltage command value Vdfb *. The control device 100 then generates the d-axis voltage command value Vd* by further compensating the first d-axis voltage command value Vdfb* by the compensation value Vdff* calculated using the q-axis inductance Lq of the motor 7 and the like.

Similarly, the control device 100 performs current control on the deviation Iq_err between the q-axis current command value Iq* and the q-axis current iq (step S5). The control device 100 extracts the pulsatile component of the electrical 6f component with respect to the q-axis current iq, from the deviation Iq_err between the q-axis current command value Iq* and the q-axis current iq (step S6). In practice, the control device 100 extracts the pulsatile component of the electrical 6f component from the deviation Iq_err by dividing the electrical 6f component into a cosine component and a sine component as described above. The control device 100 generates the compensation value V*q_ωe_6f, which will reduce the pulsatile component of the electrical 6f component extracted, to “0” (step S7). The control device 100 compensates, by the compensation value V*q_ωe_6f, the q-axis voltage command value V*q_PI, which is the value obtained by performing current control on the deviation Iq_err between the q-axis current command value Iq* and the q-axis current iq (step S8), thereby generates and outputs the first q-axis voltage command value Vqfb*. The control device 100 then generates the q-axis voltage command value Vq* by further compensating the first q-axis voltage command value Vqfb* by the compensation value Vqff* calculated using the d-axis inductance Ld of the motor 7 and the like.

Note that the control device 100 may perform the operations of steps from S1 to S4 and the operations of steps from S5 to S8 in parallel with each other, or may perform the operations of steps from S5 to S8 prior to the operations of steps from S1 to S4.

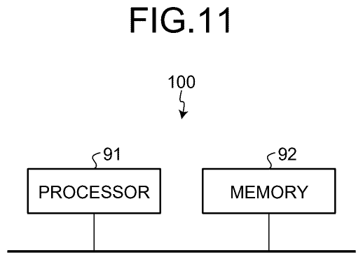

A hardware configuration of the control device 100 included in the power converting apparatus 200 will next be described. FIG. 11 is a diagram illustrating an example of hardware configuration for implementing the control device 100 included in the power converting apparatus 200 according to the first embodiment. The control device 100 is implemented by a processor 91 and a memory 92.

The processor 91 is a central processing unit (CPU) (also known as a processing unit, a computing unit, a microprocessor, a microcomputer, a processor, and a digital signal processor (DSP)) or a system large scale integration (LSI). The memory 92 can be exemplified by a non-volatile or volatile semiconductor memory such as a random access memory (RAM), a read-only memory (ROM), a flash memory, an erasable programmable read-only memory (EPROM), or an electrically erasable programmable read-only memory (EEPROM) (registered trademark). In addition, the memory 92 is not limited thereto, and may be a magnetic disk, an optical disk, a compact disc, a MiniDisc, or a digital versatile disc (DVD).

According to the present embodiment, the power converting apparatus 200 is provided in which, as described above, the control device 100 performs, in the d-axis current control unit 506, reduction control of reducing the pulsatile component of the electrical 6f component superimposed on the d-axis current id, and performs, in the q-axis current control unit 507, reduction control of reducing the pulsatile component of the electrical 6f component superimposed on the q-axis current iq. This enables the control device 100 to reduce the pulsatile components generated due to effects of dead times of the switching elements 311 to 316 included in the inverter 30 and due to an effect of a distortion of an induced voltage of the motor 7. The control device 100 is capable of reducing the pulsatile components generated due to effects of dead times of the switching elements 311 to 316 included in the inverter 30 and due to an effect of a distortion of an induced voltage of the motor 7, by performing the reduction control as described above, also when the inverter 30 has been replaced with a new one, or when the motor 7 connected to the power converting apparatus 200 has been replaced with a new one. This enables the control device 100 to reduce or prevent decrease in control stability, and also reduce or prevent generation of noise.

### Second Embodiment

The first embodiment has been described with respect to the case where the control device 100 of the power converting apparatus 200 performs reduction control of reducing pulsation of the electrical 6f component generated due to effects of dead times of the switching elements 311 to 316 included in the inverter 30 and due to an effect of a distortion of an induced voltage of the motor 7. In this respect, when the pulsation of the electrical 6f component has a very small magnitude, performing the forgoing reduction control by the control device 100 of the power converting apparatus 200 may cause, in the control device 100, control interference between the reduction control and general control of controlling the operation of the inverter 30 and of the motor 7. Occurrence of control interference may cause the control device 100 to fail to converge the deviation with a desired speed of control response, or to cause the deviation to diverge. In a second embodiment, a case will be described with respect to reduction of occurrence of control interference in the control device 100 of the power converting apparatus 200.

In the second embodiment, the power converting apparatus 200 is configured similarly to the power converting apparatus 200 of the first embodiment illustrated in FIG. 1. In addition, the control device 100 is configured similarly to the control device 100 of the first embodiment illustrated in FIG. 3. In the second embodiment, the voltage command value calculation unit 115 in the control device 100 is configured differently from the voltage command value calculation unit 115 of the first embodiment illustrated in FIG. 4.

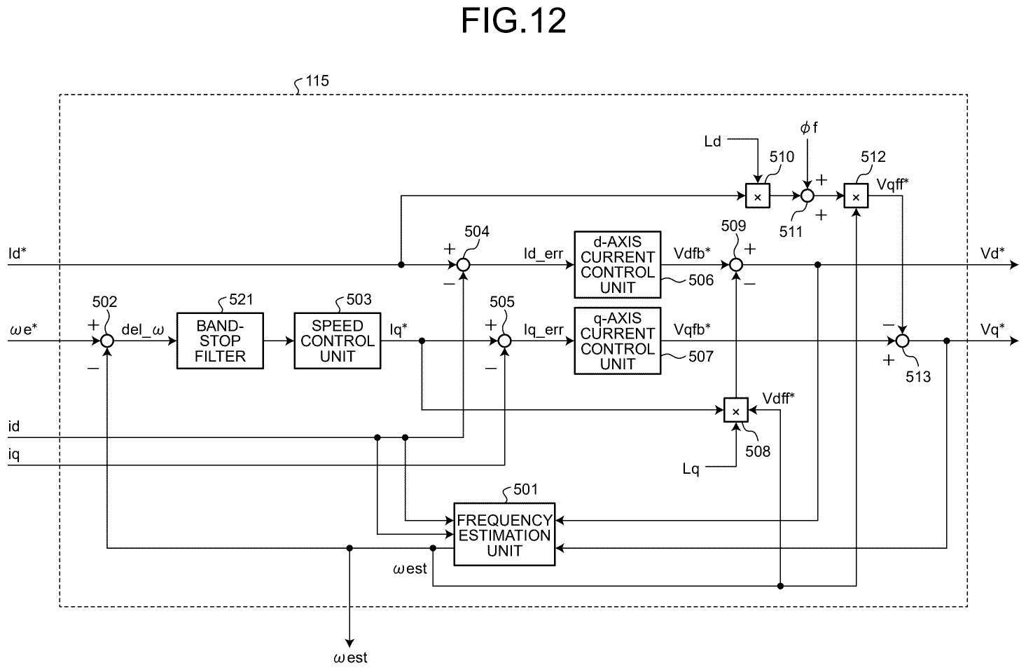

FIG. 12 is a block diagram illustrating an exemplary configuration of the voltage command value calculation unit 115 included in the control device 100 of the power converting apparatus 200 according to the second embodiment. The voltage command value calculation unit 115 of the second embodiment further includes a band-stop filter 521 in addition to the components of the voltage command value calculation unit 115 of the first embodiment illustrated in FIG. 4.

The band-stop filter 521 performs filtering operation of eliminating pulsation of the electrical 6f component from the frequency deviation del_ω between the frequency command value ωe* and the estimated frequency value ωest, calculated by the addition-subtraction unit 502. This prevents the speed control unit 503 from performing speed control on pulsation of the electrical 6f component included in the frequency deviation del_ω between the frequency command value ωe* and the estimated frequency value ωest, calculated by the addition-subtraction unit 502, thereby enabling the control device 100 to reduce occurrence of control interference between the reduction control described in the first embodiment and the speed control performed by the speed control unit 503. As described above, the control device 100 includes the band-stop filter 521 for reducing interference between the reduction control and the speed control performed during generation of the voltage command value associated with the q-axis.

In addition, the voltage command value calculation unit 115 can include a band-stop filter inside each of the d-axis current control unit 506 and the q-axis current control unit 507.

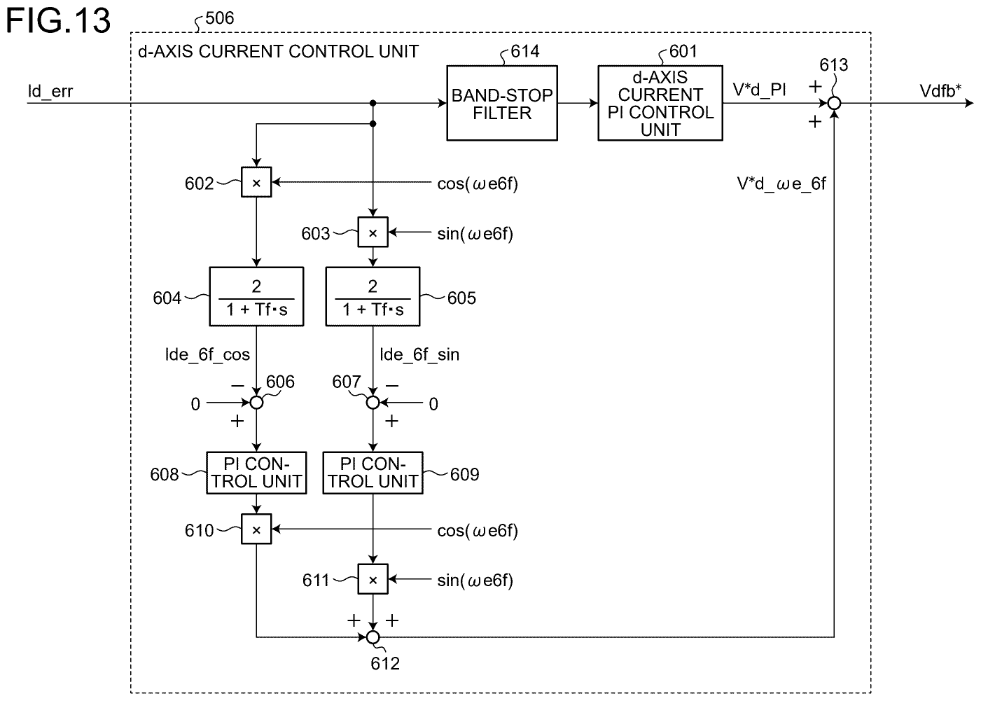

FIG. 13 is a block diagram illustrating an exemplary configuration of the d-axis current control unit 506 included in the voltage command value calculation unit 115 of the control device 100 in the power converting apparatus 200 according to the second embodiment. The d-axis current control unit 506 of the second embodiment further includes a band-stop filter 614 in addition to the components of the d-axis current control unit 506 of the first embodiment illustrated in FIG. 5.

The band-stop filter 614 performs filtering operation of eliminating pulsation of the electrical 6f component from the deviation Id_err between the d-axis current command value Id* and the d-axis current id, calculated by the addition-subtraction unit 504. This prevents the d-axis current PI control unit 601 from performing current control on pulsation of the electrical 6f component included in the deviation Id err between the d-axis current command value Id* and the d-axis current id, calculated by the addition-subtraction unit 504, thereby preventing pulsation of the electrical 6f component from being included in the d-axis voltage command value V*d_PI output from the d-axis current PI control unit 601. This enables the d-axis current control unit 506 to reduce occurrence of control interference between the reduction control described in the first embodiment and the current control. As described above, the control device 100 includes the band-stop filter 614 for reducing interference between the reduction control and the current control performed during generation of the voltage command value associated with the d-axis.

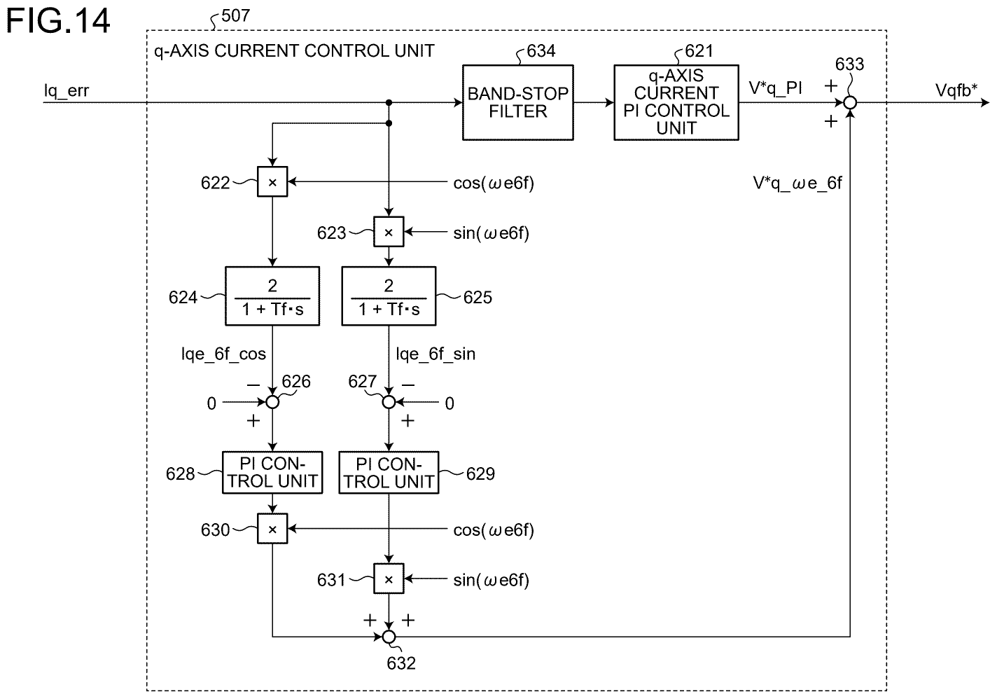

FIG. 14 is a block diagram illustrating an exemplary configuration of the q-axis current control unit 507 included in the voltage command value calculation unit 115 of the control device 100 in the power converting apparatus 200 according to the second embodiment. The q-axis current control unit 507 of the second embodiment further includes a band-stop filter 634 in addition to the components of the q-axis current control unit 507 of the first embodiment illustrated in FIG. 6.

The band-stop filter 634 performs filtering operation of eliminating pulsation of the electrical 6f component from the deviation Iq_err between the q-axis current command value Iq* and the q-axis current iq, calculated by the addition-subtraction unit 505. This prevents the q-axis current PI control unit 621 from performing current control on pulsation of the electrical 6f component included in the deviation Iq_err between the q-axis current command value Iq* and the q-axis current iq, calculated by the addition-subtraction unit 505, thereby preventing pulsation of the electrical 6f component from being included in the q-axis voltage command value V*q_PI output from the q-axis current PI control unit 621. This enables the q-axis current control unit 507 to reduce occurrence of control interference between the reduction control described in the first embodiment and the current control. As described above, the control device 100 includes the band-stop filter 634 for reducing interference between the reduction control and the current control performed during generation of the voltage command value associated with the q-axis.

Note that in the second embodiment, the control device 100 of the power converting apparatus 200 may be configured to include all three or any one or two of the band-stop filter 521 illustrated in FIG. 12, the band-stop filter 614 illustrated in FIG. 13, and the band-stop filter 634 illustrated in FIG. 14.

In addition, the control device 100 can reduce occurrence of control interference between the reduction control described in the first embodiment and the current control, by controlling the control response of the reduction control to cause the speed of the control response of the current control to be greater than or equal to a predetermined multiple of the speed of the control response of the reduction control. In the control device 100, the d-axis current control unit 506 sets, for example, the speed of the control response of the d-axis current PI control unit 601, which performs the current control, to a value greater than or equal to five times the speed of the control response provided by a group of components from the multiplication unit 602 to the addition unit 612, which perform the reduction control. By providing sufficient separation between the speed of the control response of the d-axis current PI control unit 601, which performs the current control, and the speed of the control response provided by the group of components from the multiplication unit 602 to the addition unit 612, which perform the reduction control, the d-axis current control unit 506 can reduce occurrence of control interference. Similarly, in the control device 100, the q-axis current control unit 507 sets, for example, the speed of the control response of the q-axis current PI control unit 621, which performs the current control, to a value greater than or equal to five times the speed of the control response provided by a group of components from the multiplication unit 622 to the addition unit 632, which perform the reduction control. By providing sufficient separation between the speed of the control response of the q-axis current PI control unit 621, which performs the current control, and the speed of the control response provided by the group of components from the multiplication unit 622 to the addition unit 632, which perform the reduction control, the q-axis current control unit 507 can reduce occurrence of control interference.

According to the present embodiment, the power converting apparatus 200 is provided in which, as described above, the control device 100 includes a band-stop filter at at least one location of an input stage of the speed control unit 503, an input stage of the d-axis current PI control unit 601, and an input stage of the q-axis current PI control unit 621, included in the voltage command value calculation unit 115. This enables the control device 100 to reduce occurrence of control interference between general control of controlling the operation of the inverter 30 and of the motor 7, and the reduction control described in the first embodiment to reduce the pulsatile components generated due to effects of dead times of the switching elements 311 to 316 included in the inverter 30 and due to an effect of a distortion of an induced voltage of the motor 7.

### Third Embodiment

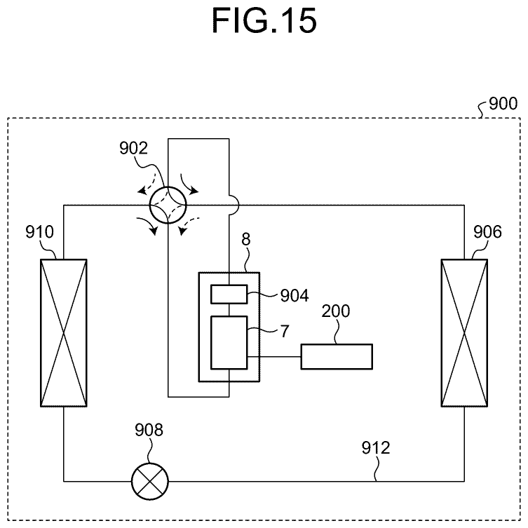

FIG. 15 is a diagram illustrating an exemplary configuration of a refrigeration cycle-incorporating device 900 according to a third embodiment. The refrigeration cycle-incorporating device 900 according to the third embodiment includes the power converting apparatus 200 described in the first embodiment or the second embodiment. The refrigeration cycle-incorporating device 900 according to the third embodiment can be used in products including a refrigeration cycle, such as an air conditioner, a refrigerator, a freezer, and a heat pump water heater. Note that, in FIG. 15, components having functionality similar to the functionality of the first embodiment and the like are designated by reference characters identical to the reference characters used in the first embodiment.

The refrigeration cycle-incorporating device 900 includes a compressor 8 incorporating the motor 7 described in the first embodiment, a four-way valve 902, an indoor heat exchanger 906, an expansion valve 908, and an outdoor heat exchanger 910, which are connected to each other via a refrigerant pipe 912.

The compressor 8 includes therein a compression mechanism 904 for compressing a refrigerant, and the motor 7 for operating the compression mechanism 904.

The refrigeration cycle-incorporating device 900 is capable of operating in heating and cooling modes according to switching operation of the four-way valve 902. The compression mechanism 904 is driven by the motor 7, which is controlled by variable speed control.

During heating operation, the refrigerant is pressurized by the compression mechanism 904 to flow out thereof, passes through the four-way valve 902, the indoor heat exchanger 906, the expansion valve 908, the outdoor heat exchanger 910, and the four-way valve 902, and returns back to the compression mechanism 904 as indicated by the solid line arrow.

During cooling operation, the refrigerant is pressurized by the compression mechanism 904 to flow out thereof, passes through the four-way valve 902, the outdoor heat exchanger 910, the expansion valve 908, the indoor heat exchanger 906, and the four-way valve 902, and returns back to the compression mechanism 904 as indicated by the broken line arrow.

During heating operation, the indoor heat exchanger 906 acts as a condenser to release heat, while the outdoor heat exchanger 910 acts as an evaporator to absorb heat. During cooling operation, the outdoor heat exchanger 910 acts as a condenser to release heat, while the indoor heat exchanger 906 acts as an evaporator to absorb heat. The expansion valve 908 decompresses and expands the refrigerant.

The configurations described in the foregoing embodiments are merely examples. These configurations may be combined with another known technology, and configurations of different embodiments may be combined together. Moreover, part of such configurations may be omitted and/or modified without departing from the spirit.

1. A power converting apparatus comprising:
a rectifier unit rectifying first alternating-current power supplied from a commercial power supply;
a capacitor connected to an output end of the rectifier unit;
an inverter connected across the capacitor, the inverter generating second alternating-current power and outputting the second alternating-current power to a motor; and
a control device controlling a rotational speed of the motor by controlling an operation of the inverter,
and performing reduction control of reducing a pulsatile component, the pulsatile component being generated due to an effect of a dead time of a switching element included in the inverter and due to an effect of a distortion of an induced voltage of the motor, the pulsatile component being superimposed on a three-phase current output from the inverter to the motor, wherein
the control device comprises
a conversion unit converting the three-phase current into a d-axis current and a q-axis current represented using a dq rotating coordinate system,
a first current control unit performing current control on a first deviation, the first deviation being a deviation between a d-axis current command value and the d-axis current,
a first compensation value generation unit generating a first compensation value that reduces the pulsatile component included in the first deviation,
a second current control unit performing current control on a second deviation, the second deviation being a deviation between a q-axis current command value and the q-axis current, and
a second compensation value generation unit generating a second compensation value that reduces the pulsatile component included in the second deviation, and
the control device compensates an output from the first current control unit by the first compensation value, and compensates an output from the second current control unit by the second compensation value.

2. The power converting apparatus according to claim 1, wherein
the control device performs control to reduce pulsatile components generated in the three-phase current, the pulsatile components having frequencies that are five times and seven times an electrical angular frequency based on rotation of the motor.

3. The power converting apparatus according to claim 1, wherein
the control device performs control to reduce pulsatile components having a frequency that is six times an electrical angular frequency based on rotation of the motor, the pulsatile components being generated in a d-axis current and in a q-axis current represented using a dq rotating coordinate system, the d-axis current and the q-axis current having been obtained by conversion from the three-phase current.

4. The power converting apparatus according to claim 1, wherein
the control device performs, in parallel with the current control, control of extracting pulsatile components having a frequency that is six times an electrical angular frequency based on rotation of the motor, included in the d-axis current and in the q-axis current, and reducing the pulsatile components extracted to generate voltage command values to control operation of the switching element.

5. The power converting apparatus according to claim 4, wherein
the control device comprises a band-stop filter for reducing interference between the reduction control and speed control performed during generation of the voltage command values associated with a q-axis.

6. The power converting apparatus according to claim 4, wherein
the control device comprises a band-stop filter for reducing interference between the reduction control and current control performed during generation of the voltage command values associated with a d-axis, and comprises a band-stop filter for reducing interference between the reduction control and current control performed during generation of the voltage command values associated with a q-axis.

7. The power converting apparatus according to claim 4, wherein
the control device controls a control response of the reduction control to cause a speed of control response of the current control to be greater than or equal to a predetermined multiple of a speed of the control response of the reduction control.

8. A motor drive device comprising the power converting apparatus according to claim 1.

9. A refrigeration cycle-incorporating device comprising the power converting apparatus according to claim 1.
